(19) United States
(12) Patent Application Publication
(10) Pub. No.: US 2009/0183225 A1
(43) Pub. Date: Jul. 16, 2009

(54) PLUGGABLE MODULES FOR TERMINAL SERVICES

(75) Inventors: Meher P. Malakapalli, Sammamish, WA (US); Ashwin Palekar, Sammamish, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 11/972,443

(22) Filed: Jan. 10, 2008

(51) Int. Cl. G06F 21/00

(52) U.S. Cl. 726/1

(57) ABSTRACT

Embodiments that facilitate the use of pluggable policy modules and authentication modules for access to a Terminal Services (TS) server are disclosed. In accordance with various embodiments, a method includes accessing one or more pluggable modules at a Terminal Services Gateway (TSG) server or a Terminal Services (TS) server. The method further includes processing a TS server access request from a TS client at the TSG server or the TS server. The TS server access request is processed in part based on the one or more pluggable modules. In one particular embodiment, the one or more pluggable modules include at least one of a connection authorization policy (CAP) module, a resource authorization policy (RAP) module, and an authentication module.

### BACKGROUND

A Terminal Services Gateway (TSG) server provides access to protected intranet resources for clients outside a firewall. The architecture and software modules built into a TSG server evaluate access requests and control access to the protected intranet resources using policies at the TSG server. However, the current architecture of TSG servers are relatively inflexible and also requires a TSG server be a member of a domain or a member of a domain cluster that includes the domain in order to authenticate and authorize users in that domain. Additionally, the current architecture of the TSG servers may also hinder integration of the TSG servers with other servers such as universal gateway server, terminal servers, as well as the implementation of technologies such as web access single sign-ins.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for processing a Terminal Services (TS) server access request using pluggable policy modules and a pluggable authentication module. In some embodiments, a method includes providing one or more pluggable modules to a Terminal Services Gateway (TSG) server or a Terminal Services (TS) server. The method further includes processing a TS server access request from a TS client at the TSG server or the TS server. The TS server access request is processed in part based on one or more pluggable modules. In at least one embodiment, the one or more pluggable modules include at least one of a connection authorization policy (CAP) module, a resource authorization policy (RAP) module, and an authentication module.

In other embodiments, a computer readable medium having computer-executable instructions that, when executed, perform acts to access one or more pluggable modules using an application program interface (API). The acts additionally include processing a TS server access request from a TS client. The TS server access request is processed at the TSG server using the one or more pluggable modules. Alternatively, the TS server access request is directly processed at the TS server using the one or more pluggable modules. In at least one embodiment, the one or more pluggable modules include at least one of a connection authorization policy (CAP) module, a resource authorization policy (RAP) module, and an authentication module.

In further embodiments, a system for accessing pluggable authorization policy and authentication modules comprises one or more processors and an application program interface (API) for interacting with one or more pluggable policy modules. The one or more pluggable policy authorization modules include one or more policies for determining the permissibility a connection between a TS client and a TSG server. Alternatively, the one or more pluggable authorization modules include one or more policies for determining the permissibility a connection between a TS client and a TS server.

Moreover, the one or more pluggable authorization modules also include one or more policies for determining the permissibility of access to a resource on the TS server from the TS client. Additionally, the system also comprises a second API for interacting with a pluggable authentication module. The pluggable authentication module is configured to verify the identity of a user that submitted an authentication to the TSG server. This identity verification is accomplished using an authentication input received at the TS client. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram illustrating an exemplary network environment in which at least one embodiment of pluggable authorization policy and authentication modules may be implemented into a Terminal Services Gateway (TSG) server.

FIG. 2 is a block diagram illustrating an exemplary Terminal Services Gateway (TSG) server that is capable of using pluggable authorization policy and authentication modules, in accordance with one or more embodiments.

FIG. 3 is a block diagram illustrating an exemplary authentication scheme in which a pluggable authentication module may be utilized to authentication users on a Terminal Services Gateway (TSG) server, in accordance with one or more embodiments.

FIG. 4 is a block diagram illustrating an exemplary Terminal Services (TS) server that is capable of using pluggable authorization policy and authentication modules, in accordance with one o more embodiments.

FIGS. 5A-5D are flow diagrams illustrating exemplary processes for using pluggable authorization policy and authentication modules on one of a Terminal Services Gateway (TSG) server or a Terminal Services (TS) server, in accordance with various embodiments.

FIGS. 6A-6C are flow diagrams illustrating exemplary processes for using pluggable policy modules in conjunction with built-in authorization policies in one of a Terminal Services Gateway (TSG) server or a Terminal Services (TS) server, in accordance with various embodiments.

FIG. 7 is a block diagram illustrating a representative computing environment.

### DETAILED DESCRIPTION

This disclosure is directed to systems and methods for processing a Terminal Services (TS) server access request using pluggable policy modules and/or a pluggable authentication module. The various pluggable modules are implemented at one of a Terminal Services Gateway (TSG) server or a Terminal Services (TS) server. The TSG server is responsible for controlling access to a TS server from a TS client that is outside of the network occupied by the TS server. Accordingly, the TSG server generally includes a built-in connection authorization policy (CAP) engine, a built in resource authorization policy (RAP) engine, and a user authentication mechanism. These engines and mechanism are used to evaluate TS server access requests that originate from TS clients.

The embodiments described herein are directed to using application program interfaces (APIs) to access the pluggable policy modules and the pluggable authentication module. The pluggable policy modules may provide authorization policies that either replace or supplement the authorization policies that are included in the built-in CAP and RAP engines of the TSG server. In this way, embodiments of the present disclosure enable the TSG server to evaluate TS server access requests based on custom policies that are not found in the built-in engines.

The pluggable authentication module in accordance with the embodiments described herein may enable the TSG server to authenticate users that are seeking to join domains that are not occupied by the TSG server. Likewise, in other embodiments, the TS Server is also provided with the ability to use pluggable policy modules and/or a pluggable authentication module to evaluate access requests and authenticate users.

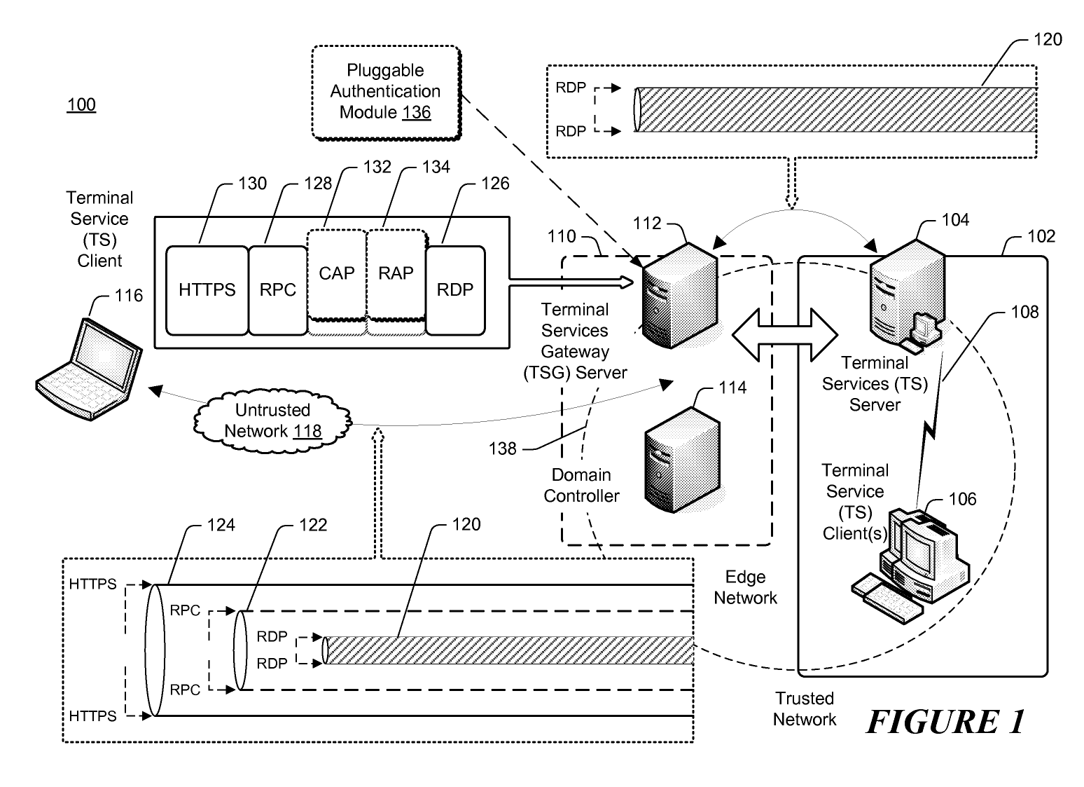

Thus, embodiments of the present disclosure may increase the adaptability and performance of the TSG server. Similarly, alternative embodiments may also increase the adaptability and performance of the TS server. Various examples of pluggable modules for use with terminal services are described below with reference to FIGS. 1-7.

### Exemplary Network Environment

FIG. 1 is a block diagram illustrating an exemplary network environment 100 in which one or more embodiments of pluggable authorization policy and authentication modules may be implemented into a Terminal Services Gateway (TSG) server. As shown, the network environment 100 includes a trusted network 102. The trusted network 102 may correspond to a data processing infrastructure provided by any type of organization, such as a corporation, educational institution, governmental institution, and other entities. The trusted network 102 may include a collection of server computers, networks (such as intranets), routers, data storage devices, and so on, that are interconnected via standardized networking infrastructures and protocols. For example, the trusted network 102 may be a local area network (LAN) or wide area network (WAN).

The trusted network 102 may include a Terminal Services (TS) server 104 and one or more internal TS clients 106. The internal TS clients 106 are connected to the TS server 104 by an internal networking infrastructure 108. The one or more internal TS clients 106 may include any type of client device that interacts with the TS server 104 via the trusted network 102. In various embodiments, the one or more internal TS clients 106 may include personal computers, laptop computers, personal digital assistants (PDAs), stylus-type input devices, mobile telephones, game consoles, a set-top box associated with a television sets, and other networked devices.

In turn, the TS server 104 may provide computer resources to the internal TS clients 106 via a remote desktop protocol (RDP). RDP is a protocol that enables a TS client to exchange data with a TS server so that a user can work with computer resources on the TS server at a TS client. The computer resources may include applications, processes, and services that reside on the TS Server 104. For example, a user may use the internal TS client 106 to access a word processing program on the TS server 104 to draft a document at the TS client 106. The user may then save the document to the TS server 104.

The trusted network 102 may be equipped, for example, with an edge network 110. The edge network 110 may also be referred to as the demilitarized zone (DMZ). Generally speaking, the edge network 110 is an isolated network that is placed between an organization's trusted network (e.g., trusted network 102) and other networks, such as those networks associated with the Internet. The edge network may serve to filter network traffic that flows from any network to the trusted network 102. According, the edge network 110 may provide a layer of protection for the trusted network 102. The edge network 110 may include a TSG server 112 as well as a domain controller 114. The functions of the TSG server 112 and the domain controller 114 are further described below.

The network environment 100 also includes one or more external TS clients 116 that are outside of the trusted network 102. In one instance, the external clients 116 may represent any type of client device that interacts with the TS Server 104 via an untrusted network 118. Like their internal counterparts, the one or more external TS clients 116 may include personal computers, laptop computers, personal digital assistants (PDAs), stylus-type input devices, mobile telephones, game consoles, a set-top box associated with a television sets, and other networked devices. The untrusted network 118 may comprise of any type of communication network mechanism that is not under the control of the trusted network 102. In one embodiment, the network 118 may include the Internet. The external TS clients 116 may exchange network communication with the TS server 104 of the trusted network 102 via untrusted network 118. Furthermore, any network communication between the external TS clients 116 and TS server 104 also flows through the TSG server 112 of the edge network 110.

Typically, the external TS clients 116 may interact with the TS Server 104 via the exchange of RDP data 120. However, because the RDP data 120 is coming from an external client 116 rather than an internal client 106, the RDP data is altered for transfer over the untrusted network 118. In one instance, the RDP data 120 is embedded in Remote Procedure Call (RPC) protocol data 122. The RPC protocol data 122, in turn, is further layered within Hypertext Transfer Protocol Security (HTTPS) protocol data 124 for transfer over the untrusted network 118 (e.g., Internet). The HTTPS protocol is a widely accepted protocol for the secure transfer of network communication over the Internet.

Thus, according to various embodiments, the TSG server 112 may be employed for alternately encoding and extracting RDP data 120 into and from the HTTPS protocol data 124. Further, the TSG server 112 also transfers and receives the RDP data 120 to and from the TS server 104. In other words, the TSG server 112 acts as a proxy that forwards RDP data 120 between the external TS client 116 and the TS server 104. The TSG Server 112 may respectively accomplish these processes via engines built into its operating software. These engines may include a RDP engine 126 that is responsible for processing RDP data, an RPC engine 128 that encodes and decodes RPC protocol data, and an HTTPS engine 130 that encodes and decodes HTTPS data. As further described below, each of the RPC engine 128 and the HTTPS engine 130 may further possess authentication capabilities.

The TSG server 112 may further include a built-in connection authorization policy (CAP) engine 132 and a built-in resource authorization policy engine (RAP) 134. The CAP engine 132 generally controls connections between the external TS client 116 and the TSG server 112. For example, the CAP engine 132 may include one or more policies that grant specific external TS client 116 access to the TSG server 112 in response to a connection request. In other embodiments, the CAP engine 132 may also include policies that specify criteria that the TS clients 102 need to fulfill to obtain connections to the TSG server 112. For example, the CAP engine 132 may include a connection authorization policy which states that the external TS client 116 must be capable of an SSL (secure socket layer) connection in order to exchange network communications with the TSG server 112.

In other embodiments, the RAP engine 134 may include policies that authorize access to resources in the trusted network 102. For example, these policies may specify the particular TS server, such as TS server 104, that a user may connect to from the external TS client 116. The policies in the RAP engine 134 may also specify the particular ports on which the connections between the external TS client 116 and the TS server 104 may be established. In this way, the CAP engine 132 and the RAP engine 134 are designed to govern actions that the external TS clients 116 may perform while interacting with TS server 104. However, the current CAP engine 132 and the RAP engine 134 are cohesive integrated into the operating software of the TSG server 112. This integration does not enable the provision of custom policies and policy engines that are capable of evaluating connection and access requests from the external TS clients 116 based on criteria and policies not present in the built-in CAP engine 132 and RAP engine 134.

Embodiments of the TSG server 112, in accordance with this disclosure, may have the ability to access policy modules that are not integral parts of the TSG server 112. For instance, these policy modules may include custom policy modules that contain policies that are different from the policies of the CAP engine 132 and the RAP engine 134. In essence, these embodiments enable the replacement of the CAP engine 132 and the RAP engine 134 with pluggable and extensible substitutes. Other embodiments of the TSG server 112 may have the capacity to supplement its CAP engine 132 and the RAP engine 134 with comparable external engines. For example, embodiments of the TSG server 112 in accordance with the current disclosure may have the ability to govern TS client access and interaction based in part on the policies contained in the built-in CAP engine 132 and RAP engine 134, and in part on the policies contain in an external CAP engine and an external RAP engine.

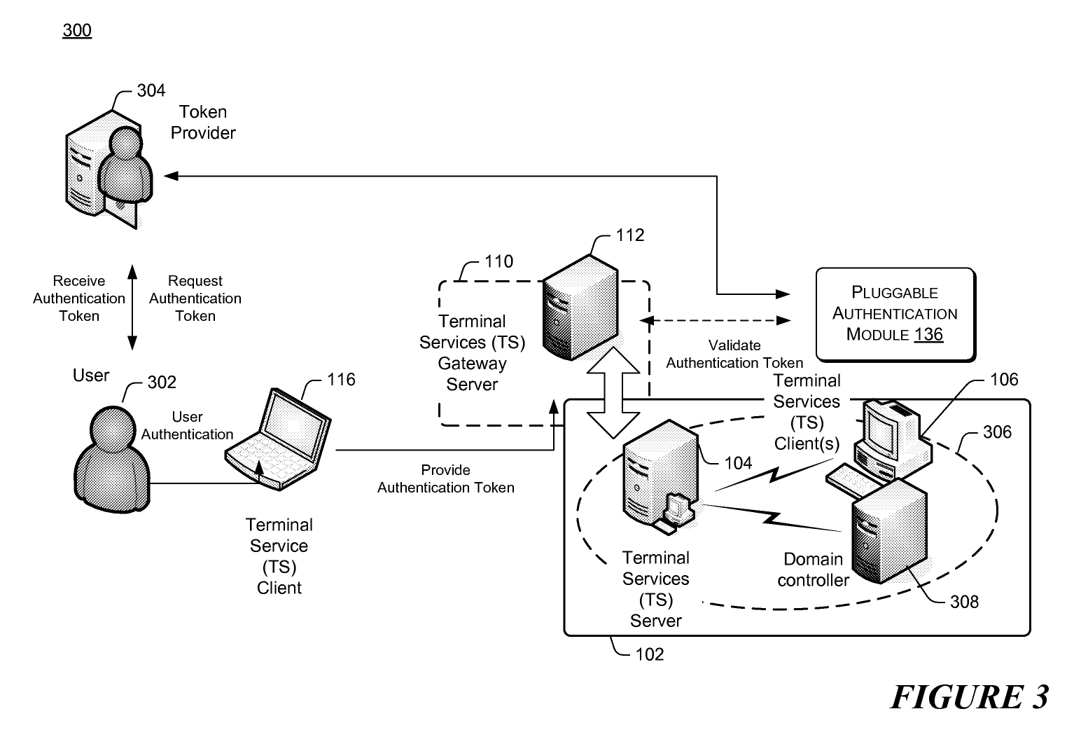

The TSG server 112, as shown, may also be supplemented with a pluggable/extensible authentication module 136. The authentication module 136 may provide user authentication functions that replace authentication functions implemented by the RPC engine 128 and the HTTPS engine 130. Currently, the authentication of a user that requests access to the trusted network 102 from the external TS client 116 is performed by at least one of the RPC engine 128 and the HTTPS engine 130 of TSG server 112. However, the architectures of HTTPS and RPC may limit the capability of TSG server 112 to authenticate users. For example, in order to authenticate external TS client 116 for a domain 138 that is controlled by the domain controller 114, the TSG server 112 is required to be a member of the domain 138 as depicted in FIG. 3. Alternatively, in some embodiments, the TSG server 112 may also authenticate external TS clients 116 if it is a member of a domain that is clustered with the domain 138. However, if the TSG server 112 is not a member of the domain 138 or a member of a domain that is clustered with the domain 138, the TSG server 112 is not capable of authenticating external TS clients 116.

On the other hand, embodiments of the authentication module 136 may be configured to be free from such domain constraints. Thus, as further described below, the pluggable/extensible authentication module 136 may provide additional authentication capabilities to the TSG server 112.

### Exemplary Terminal Services Gateway (TSG) Server Architecture

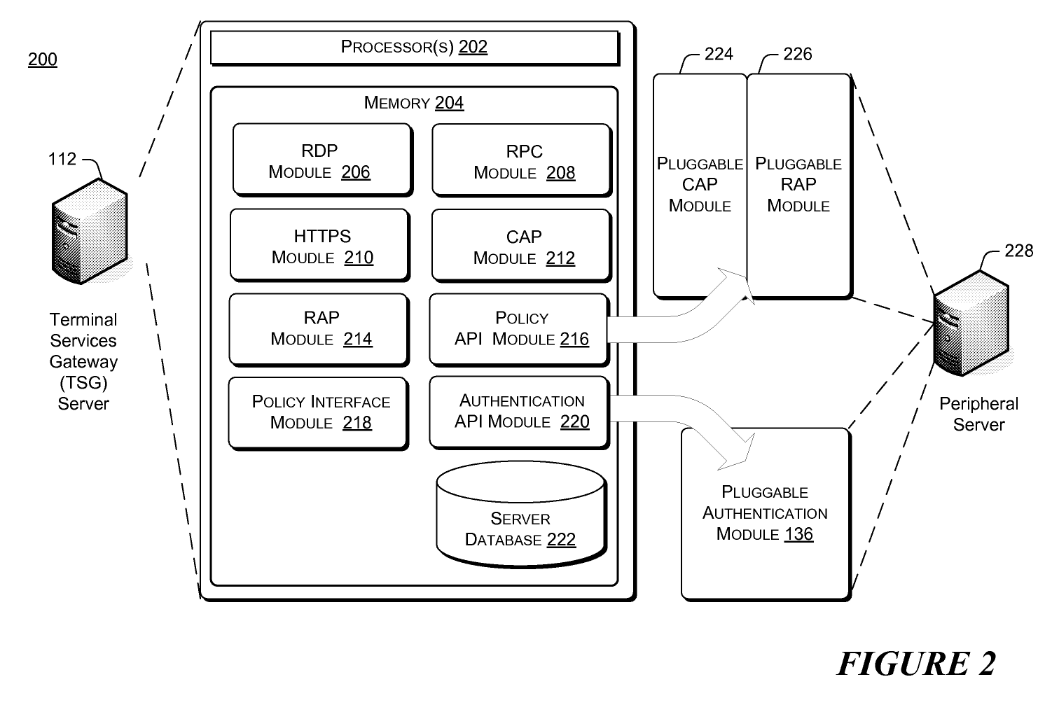

FIG. 2 is a block diagram illustrating selective components of the exemplary TSG server 112, in accordance with one or more embodiments that provide pluggable modules for Terminal Services. Thus the embodiments of FIG. 2 may be described with reference to the features shown in, and described above, in relation to FIG. 1. As described above, the TSG server 112 is capable of using pluggable authorization policy and authentication modules. The TSG server 112 has processing capabilities and memory suitable to store and execute computer-executable instructions. In one example, the TSG 112 includes one or more processors 202 and memory 204. The memory 204 may include volatile and nonvolatile memory, removable and non-removable media implemented in any method or technology for storage of information, such as computer-readable instructions, data structures, program modules or other data. Such memory includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, redundant arrays of independent disks (RAID) storage systems, or any other medium which can be used to store the desired information and which can be accessed by a computer system.

The memory 204 may store a RDP module 206, a RPC module 208, a HTTPS module 210, a CAP module 212, a RAP module 214, a policy interface module 218, a policy application program interface (API) module 218, an authentication API module 220, and a server database 222. However, that exemplary TSG server 112 may also include other modules that facilitate the functions of the server.

The RDP module 206 may include the RDP engine 126, which is configured to provide data that enables a user to work with computer resources on the TS server 104 from the internal TS client 106 and the external client 116. The RPC module 208 may include the RPC engine 128, which is configured to further package and extract the RDP data provided by the RDP engine 206. Further, as described above, the RPC engine 128 may include the ability to authenticate users for providing access to the TS server 104. Likewise, the HTTPS module 210 may include the HTTPS engine 130, which is configured to package and extract HTTPS data. Moreover, as describe above, the HTTPS engine 130 may include the ability to authenticate users for providing access to the TS server 104. The CAP module 212 and the RAP modules 214 may respectively include the CAP engine 132 and the RAP engine 134. As further described above, the CAP engine 132 and the RAP engine 134 may include various policies that regulate access to the TS server 104.

The policy API module 216 includes one or more APIs that enables the TSG Server 112 to interact with the pluggable CAP module 224 and the pluggable RAP module 226. Moreover, the policy interface module 218 may control the policy API module 216. The pluggable CAP module 224 may include a custom CAP engine and custom connection authorization policies. The custom connection authorization policies are policies that are not included in the CAP module 212. Similarly, the pluggable RAP module 226 may include a custom RAP engine and custom resource authorization policies which are not found in the RAP module 214.

In some embodiments, each of the pluggable CAP module 224 and the pluggable RAP module 226 may provide authorization policies that are intended to replace the policies in the CAP module 212 and the RAP module 214, respectively. For example, each of the pluggable CAP module 224 and the RAP module 222 may include a flag that designates the module as containing substitute policies. Accordingly, the policy interface module 218 may recognize these flags and cause the TSG server 112 to execute the pluggable CAP module 224 in place of the CAP module 212, and/or execute the pluggable RAP module 226 in place of the RAP module 214.

In alternative embodiments, each of the pluggable CAP module 224 and the pluggable RAP module 226 may provide authorization policies that are intended to supplement the policies in the CAP module 212 and the RAP module 214, respectively. For example, the pluggable CAP module 224 may include policies that provide additional criteria that an external TS client 116 must satisfy to connect to the TSG server 112. In such a scenario, each of the pluggable CAP module 224 and the RAP module 222 may include a flag that designates the module as containing supplemental policies. In turn, the policy interface module 218 may recognize these flags and cause the TSG server 112 to execute the CAP module 212 in conjunction with the pluggable CAP module 224, and/or the RAP module 214 in conjunction with the pluggable RAP module 226.

The authentication API module 220 is designed to enable the TSG server 112 to interact with the authentication module 136. As described above, the authentication module 136 may enable the TSG server 112 to authenticate users without being constrained by domain designations. The authentication module 136 may be configured to authenticate a user using a variety of methods. These methods may include the use of passwords, cookies, digital certificates, biometric data, as well as other identification tokens. Thus, if directed to do so, the authentication API module 220 may cause the TSG server 112 to bypass the authentication capabilities of the RPC module 208 and the HTTPS module 210 and implement the provided authentication module 136.

The policy interface module 218 and the authentication API module 220 may connect with any suitable server, such as a peripheral server 228, to respective interface with the pluggable CAP module 224, the pluggable RAP module 226, and the pluggable authentication module 136. In some embodiments, the TSG server 112 may use the policy interface module 218 and the authentication API module 220 to access the appropriate pluggable module directly from the peripheral server 228. In other embodiments, the interface modules may import the appropriate pluggable module into the database 222 of the TSG server 112 prior to executing one of more of the pluggable modules.

### Exemplary Pluggable Authentication Scheme

FIG. 3 is a block diagram illustrating an exemplary authentication scheme 300 in which one or more embodiments of a pluggable authentication module may be utilized to authentication users on a Terminal Services Gateway (TSG) server. Thus, FIG. 3 may be described with reference to features shown, and described above, in reference to FIGS. 1 and 2. As described above, the TSG server 112 is located in an edge network 110, and the TS server 104 is located in the trusted network 102.

In the authentication scheme 300, the user 302 may contact a token provider 304 to request an authentication token. The authentication token may be in the form of a cookie, a digital certificate, a password, or any other representation that indicates that a user has been granted an access privilege. Accordingly, the token provider 304 may be a certificate authority (CA), e.g., a trusted third party that is entrusted with the verifying the identity of the user 302 and providing digital certificates. Also, the token provider 304 may be a web server that provides HTTPS cookies to the user 302. In other examples, the token provider 304 may be a network server that issues a user logon and a password to the user 302. Alternatively, the token provider 304 may store biometric data (e.g., fingerprints) obtained from the user 302, in essence turning the biometric traits of the user 302 into “issued” authentication tokens. In these examples, the pluggable authentication module 136 may interface with the token provider 304 so that it may formulate user authentication policies based on the provided authentication tokens.

However, in other examples, the authentication module 136 may be capable of directly issuing authentication tokens (e.g., cookies, digital certificates, passwords, and biometric data). In such examples, the token provider 304 may be an intermediary server that provides a network connection for the user 302 to obtain the authentication tokens without the need to first authenticate with the TSG server 112.

Once the user 302 has received an authentication token from the token provider 304, the user 302 may authenticate the user's identity to the pluggable authentication module 136. The user 302 may provide the authentication token to the pluggable authentication module 136 via the external Terminal Services (TS) client 116. For instance, cookies and digital certificates may be directly submitted as data files, while biometric authentication tokens may be submitted via a biometric reader (e.g., fingerprint scanner) (not shown) that interfaces with the TS client 116. In one embodiment, cookies may be submitted from the external TS client 116 to the TSG server 112 by the implementation of anonymous Internet Information Services (IIS) and RPC connections. The cookie is then sent via these connections as RDP data. Once the pluggable authentication module 136 receives the authentication token, it may validate the authentication token to determine whether the user 302 should be permitted access to the TS server 104.

As further shown in FIG. 3, while the TS Server 104 is located, along with internal clients 106, in a domain 306 that is controlled by a domain controller 308, the TSG server 112 is not located in the domain 306. Nevertheless, the pluggable authentication module 136 is free from the domain constraints of the built-in authentication mechanisms (e.g., as provided by the RPC engine 128) of the TSG server 112. Thus, the pluggable authentication module 136 may provide the TSG server 112 with the ability to authenticate the user 302 despite the fact that the TSG server 112 is not located in the domain 306.

### Exemplary Terminal Services (TS) Server Architecture

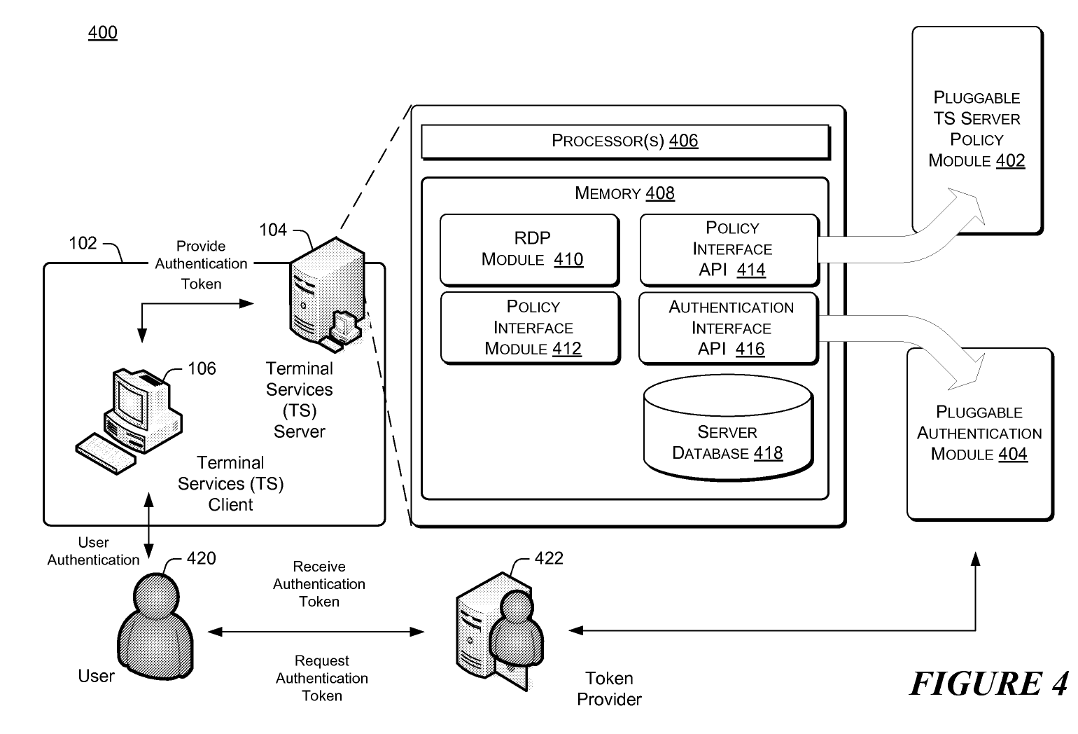

FIG. 4 is a block diagram illustrating selective components of the exemplary Terminal Services (TS) server 104, in accordance with embodiments that provide pluggable modules for Terminal Services. Thus, FIG. 4 may be described with reference to features shown, and described above, in reference to FIGS. 1-3. The TS server 104 may have built-in connection and resource access control functions. Specifically, the TS server 104 may control the access provided to the internal TS clients 106, which occupy the same trusted network 102. Thus, according to various embodiments, these connection and resource access control functions may also be enhanced with a pluggable TS server policy module 402, and a pluggable authentication module 404.

The TS server 104 has processing capabilities and memory suitable to store and execute computer-executable instructions. In one example, the TS server 104 includes one or more processors 406 and memory 408. The memory 408 may include volatile and nonvolatile memory, removable and non-removable media implemented in any method or technology for storage of information, such as computer-readable instructions, data structures, program modules or other data. Such memory includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, redundant arrays of independent disks (RAID) storage systems, or any other medium which can be used to store the desired information and which can be accessed by a computer system.

The memory 408 may store a RDP module 410, a policy interface module 412, a policy application program interface (API) module 414, an authentication API module 416, and a server database 418. The RDP module 410 may include an RDP engine that is configured to enables a user to work with computer resources on the TS server 104 from the internal TS client 106 and the external client 116.

The policy API module 414 includes one or more APIs that enables the TS Server 104 to interact with the pluggable TS server policy module 402. Moreover, the policy interface module 412 may use the policy API module 414 to access and execute the policies in the pluggable TS server policy module 402. The pluggable TS server policy module 402 may include authorization policies that enables and disables various features and operations of the TS server 104. These authorization policies are not included in the TS server 104.

In some embodiments, the pluggable TS server policy module 402 may provide authorization policies that are intended to replace the authorization policies in the TS server 104. The authorization policies in the TS server 104 may be configured to control TS client access to the TS server 104. In some embodiments, the replacement authorization policies of the pluggable TS server policy module 402 may provide additional criteria for the control of TS client access to the TS server 104. In other embodiments, the replacement policies may enable or disable various features and operations of the TS Server 104. For example, the pluggable TS server policy module 402 may include an authorization policy that states a drive redirection feature, which may be used to access data storage devices that are not present on the TS server 104, is disabled. In one embodiment, the pluggable TS server policy module 402 may include a flag that designates the module as containing substitute policies. Accordingly, the policy interface module 412 may recognize these flags and cause the TS server 104 to execute the policies in the pluggable TS server policy module 402 in place of the authorization policies built into the TS server 104.

In alternative embodiments, the pluggable TS server policy module 402 may provide authorization policies that are intended to supplement the authorization policies built into the TS server 104. For example, the pluggable TS server policy module 402 may include authorization policies that provide additional criteria, such as having an up-to-date anti-viral program, which a TS client must satisfy to access the TS server 104. In such a scenario, the pluggable TS server policy module 402 may include a flag that designates the module as containing supplemental policies. In turn, the policy interface module 412 may recognize these flags and cause the TS server 104 to execute the policies in the pluggable TS server policy module 402 in conjunction with the authorization policies in the TS server 104.

The authentication API module 416 is designed to enable the TS server 104 to interact with the pluggable authentication module 404. The authentication module 136 may enable the TS server 104 to authenticate users using a variety of authentication methods not present in the TS server 104. These methods may include the use of passwords, cookies, digital certificates, biometric data, as well as other identification tokens. Thus, if directed to do so, the authentication API module 416 may cause the TS server 104 to bypass its authentication capabilities and implement the authentication mechanism of the authentication module 136. It will be appreciated that similar to the instance of the TSG server 112, the pluggable modules 402-404 may be imported into a database 418 of the TS server 104 prior to execution.

In an exemplary authentication scheme, the user 420 may contact a token provider 422 to request an authentication token. The authentication token may be in the form of a cookie, a digital certificate, a password, or any other representation that indicates that a user has been granted an access privilege. The token provider 422 is similar to the token provider 304 described with reference to FIG. 3. Accordingly, the pluggable authentication module 404 may interface with the token provider 422 so that it may formulate user authentication policies based on the provided authentication tokens.

In other examples, the pluggable authentication module 404 may be capable of directly issuing authentication tokens (e.g., cookies, digital certificates, passwords, and biometric data). In such examples, the token provider 422 may be an intermediary server that provides a network connection for the user 4202 to obtain the authentication tokens without the need to first authenticate with the TS server 104.

Once the user 420 has received an authentication token from the token provider 422, the user 420 may authenticate the user's identity to the pluggable authentication module 404. The user 420 may provide the authentication token to the pluggable authentication module 404 via the internal TS client 106. Upon receiving the authentication token, the pluggable authentication module 136 may validate the authentication token to determine whether the user 420 should be permitted access to the TS server 104.

### Exemplary Processes

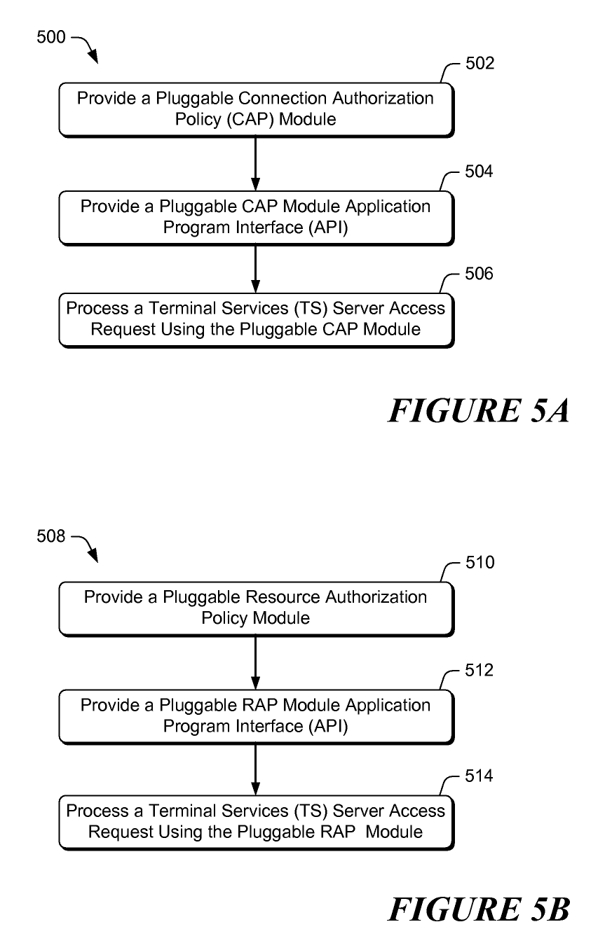

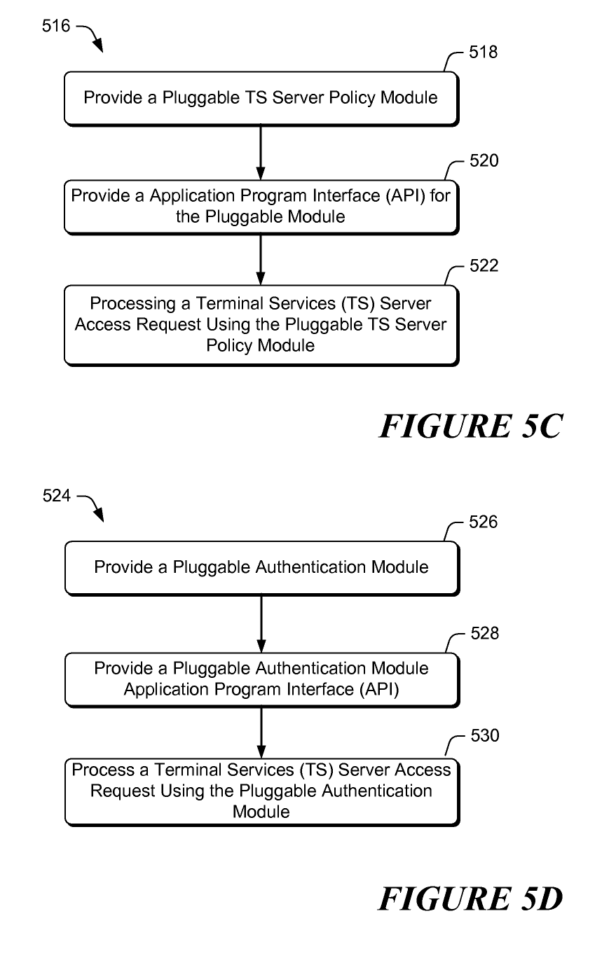

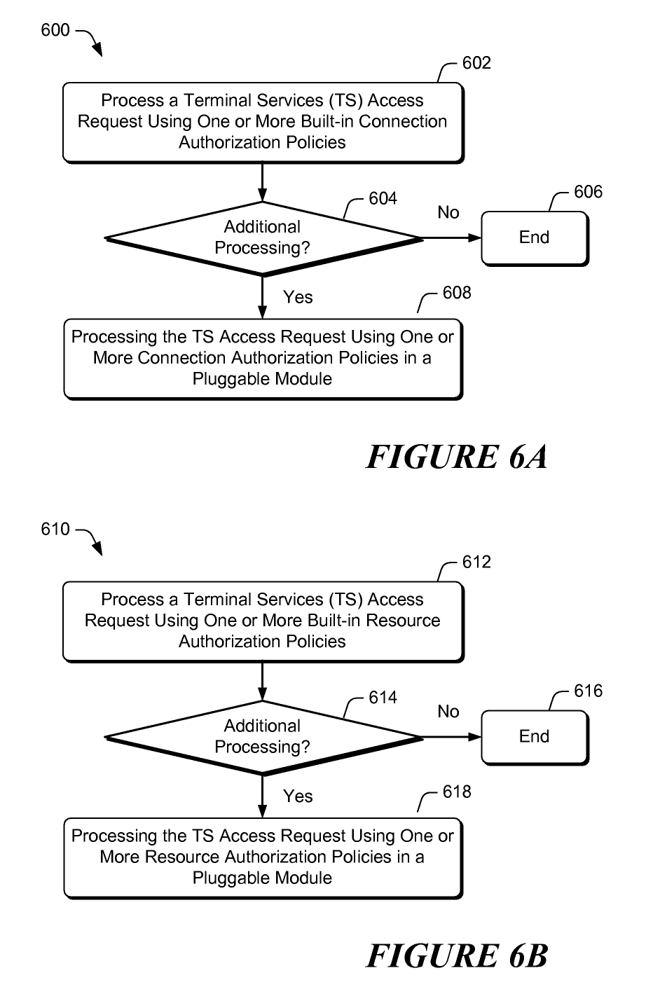

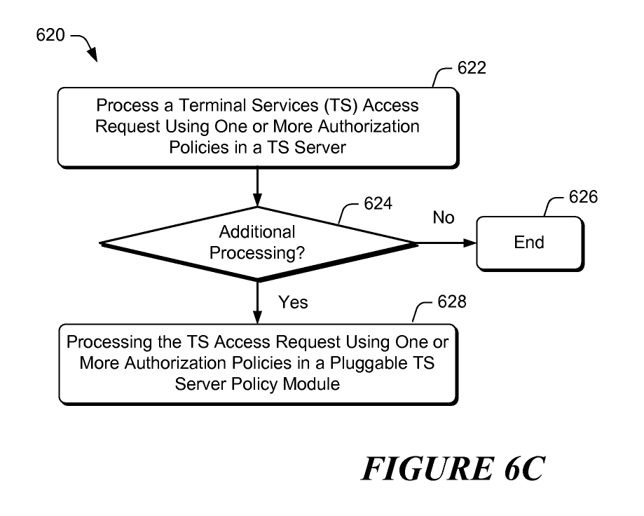

FIGS. 5A-5D and 6A-6C illustrate exemplary processes that facilitate the implementation of one or more embodiments of differentiated access to networked resources. The exemplary processes in FIGS. 5A-5D and 6A-6C are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to the network environment 100 of FIG. 1, the Terminal Services Gateway (TSG) architecture 200 of FIG. 2, and the Terminal Services (TS) architecture 400 of FIG. 4. However, the processes may be implemented in other network environments and architectures.

FIGS. 5A-5D are flow diagrams that illustrate exemplary processes for using pluggable authorization policy and authentication modules on one of a TSG server or a TS server, in accordance with embodiments that provide pluggable modules for Terminal Services. Specifically, FIG. 5A illustrates a process 500 for processing a TS server access request using a pluggable connection authorization policy (CAP) module. Likewise, FIG. 5B illustrates a process 508 for processing a TS server access request using a pluggable resource authorization policy (RAP) module. Additionally, FIG. 5C illustrates a process 516 for processing a TS server access request using a pluggable TS server policy module. Further, FIG. 5D illustrates a process 524 for processing a TS server access request using a pluggable authentication module.

As shown in FIG. 5A, the process 500 includes providing a pluggable CAP module at block 502. In some embodiments, the TSG server 112 is provide with the pluggable CAP module 224. According to various embodiments, the pluggable CAP module 224 may include a CAP engine and connection authorization policies that are different from those built into the TSG server 112.

At block 504, an application program interface (API) for the pluggable module may be provided. According to various embodiments, the API may be provided to the TSG server 112 (e.g., policy interface API module 216). In one embodiment, the provision of the API for the pluggable module may enable the TSG server 112 to access the CAP module 224.

At block 506, a TS server access request may be processed using the CAP module to determine whether a TS client's connection to the TSG server 112 is permissible. According to various embodiments, the processing of the TS server access request may occur on the TSG server 112

As shown in FIG. 5B, the process 508 includes providing a pluggable RAP module at block 510. In some embodiments, the TSG server 112 is provided with the pluggable RAP module 226. According to various embodiments, the pluggable RAP module may include an RAP engine and resource authorization policies that are different from those built into the TSG server 112.

At block 512, an application program interface (API) for the RAP module may be provided. According to various embodiments, the API may be provided to the TSG server 112 (e.g., policy interface API module 216). In one embodiment, the provision of the API for the pluggable module may enable the TSG server 112 to access the RAP module 226.

At block 514, a TS server access request may be processed using the RAP module to determine whether a TS client should be permitted access to computer resources on the TS server 104. According to various embodiments, the processing of the TS server access request may occur on the TSG server 112.

As shown in FIG. 5C, the process 516 includes providing a pluggable TS server policy module at block 518. In some embodiments, the pluggable TS server policy module 402 is provided to the TS server 104. At block 520, an application program interface (API) for the TS server policy module 402 may be provided. According to various embodiments, the API may be provided to the TS server 104 (e.g., policy interface API module 414). In one embodiment, the provision of the API for the pluggable module may enable the TS server 104 to access the policies in the pluggable TS server policy module 402.

At block 522, a TS server access request may be processed using the pluggable TS server policy module. For example, the policies in the pluggable TS server policy module 402 may state that the TS server access request may be granted if the originating TS client 106 has an up-to-date anti-viral program. In other instances, features and operations of the TS server 104, e.g., drive redirection, may be enabled or disabled according to the policies in the pluggable TS server policy module 402 during the processing of the TS server access request.

As shown in FIG. 5D, a pluggable authentication module is provided at block 526 in process 524. In some embodiments, a pluggable authentication module, such as the pluggable authentication module 136, is provided to the TSG server 112. In other embodiments, the pluggable authentication module 404 is provided to the TS server 104. According to various embodiments, the pluggable authentication module 136 may enable the TSG server 112 to authenticate users for a TS server 104 even if the TSG server 112 and the TS server 104 are not in the same domain. In other embodiments, the pluggable authentication module 404 may provide alternative authentication mechanisms to the TS server 104.

At block 528, an application program interface (API) for the authentication module may be provided. According to various embodiments, the API may be provided to one of the TSG server 112 and the TS server 104 (e.g., authentication API modules 220 and 416), respectively. The provision of the API for the authentication module may enable each of the corresponding servers to access the respective authentication module.

At block 530, a TS server access request may be processed using the authentication module to determine whether the user should be permitted access to the TS server 104 is permissible. According to various embodiments, the processing of the TS server access request may occur on one of the TSG server 112 or the TS server 104.

FIGS. 6A-6C are flow diagrams illustrating exemplary processes for using pluggable policy modules in conjunction with built-in authorization engines in one of a Terminal Services Gateway (TSG) server or a Terminal Services (TS) server. Specifically, FIG. 6A illustrates a process 600 that uses a connection authorization policy (CAP) module with built-in connection authorization policies of a TSG server.

FIG. 6B illustrates a process 610 that uses a resource authorization policy (RAP) module with built-in resource authorization policies in a TSG server. Likewise, FIG. 6C illustrates a process 620 that uses the policies in a TS server policy module with built-in authorization policies of a TS server.

According to the process 600 shown in FIG. 6A, a Terminal Services (TS) server access request is processed using one or more built-in connection authorization policies at block 602. In some embodiments, the connection authorization policies are included in a connection authorization policy (CAP) module, such as the CAP module 224, which is included in a TSG server, such as the TSG server 112. For example, the connection authorization policies in the CAP module 224 may determine the permissibility of connections to the TSG 112 from an external TS client 116.

At decision block 604, a determination may be made as to whether the TS server access request needs additional processing using authorization policies from a pluggable module. For example, the TSG Server 112 may make the determination of whether the TS server access request should be further processed using the connection authorization policies in the pluggable CAP module 224 As described above, the TSG server 112 may make such a determination in the various embodiments based on a flag present in the pluggable CAP module 224. If it is determined that the TS server access request does not needs additional processing (“no” at decision block 604), the process 600 ends at block 606. Accordingly, the permissibility of a connection to the TSG server 112, (which ultimately provides a connection to the TS server 104), is determined by the built-in policies.

However, if it is determined that the TS server access request is to be further processed, (“yes” at decision block 604), the process 600 may proceed to block 608. At block 608, the TS server access request is further processed using one or more policies of a pluggable module to further determine whether the TS server access request is permissible. For example, the pluggable CAP module 224 may be used for the TSG server 112, (which ultimately provides a connection to the TS server 104).

Likewise, according to the process 610 shown in FIG. 6B, a Terminal Services (TS) access request is processed using one or more built-in resource authorization policies at block 612. In some embodiments, the resource authorization policies are included in a resource authorization policy (RAP) module, such as the RAP module 226, which is included in a TSG server, such as the TSG server 112. For example, the resource authorization policies in the RAP module 226 may determine the permissibility of resources to the TSG 112 from an external TS client 116.

At decision block 614, a determination may be made as to whether the TS server access request needs additional processing using authorization policies from a pluggable module. For example, the TSG Server 112 may make the determination of whether the TS server access request should be further processed using the resource authorization policies in the pluggable RAP module 226. As described above, the TSG server 112 may make such a determination in the various embodiments based on a flag present in the pluggable RAP module 226.

If it is determined that the TS server access request does not needs additional processing (“no” at decision block 614), the process 610 ends at block 616. Accordingly, the permissibility of access to a resource on the TS server 104 is determined by the built-in policies.

However, if it is determined that the TS server access request is to be further processed, (“yes” at decision block 614), the process 610 may proceed to block 618. At block 618, the TS server access request is further processed using one or more policies of a pluggable RAP module to further determine whether the TS server access request is permissible. For example, the pluggable RAP module 226 may be used for the TSG server 112.

According to the process 620 shown in FIG. 6C, a Terminal Services (TS) server access request is processed using one or more built-in authorization policies at block 622. In some embodiments, the authorization policies are included in the TS server 104. For example, the authorization policies on the TS server 104 may determine the features and operations of the TS server 104 in response to a TS access request from an internal TS client 106.

At decision block 624, a determination may be made as to whether the TS server access request needs additional processing using authorization policies from a pluggable module. For example, the TS server 104 may make a determination of whether the TS access request should be further processed using the authorization policies in the pluggable TS server policy module 402.

As described above, the TS server 104 may make such a determination in the various embodiments based on a flag present in the pluggable TS server policy module 402. If it is determined that the TS server access request does not needs additional processing (“no” at decision block 624), the process 620 ends at block 626. Accordingly, the features and operations of the TS server 104 in response to the TS access request are determined by the built-in policies.

However, if it is determined that the TS server access request is to be further processed, (“yes” at decision block 624), the process 620 may proceed to block 628. At block 628, the TS server access request is further processed using one or more policies of a pluggable module to further determine whether the TS server access request is permissible, and/or the features and operations of the TS server 104. For example, authorization policies in the pluggable TS server policy module 402 may be used for the TS server 104.

### Exemplary Computing Environment

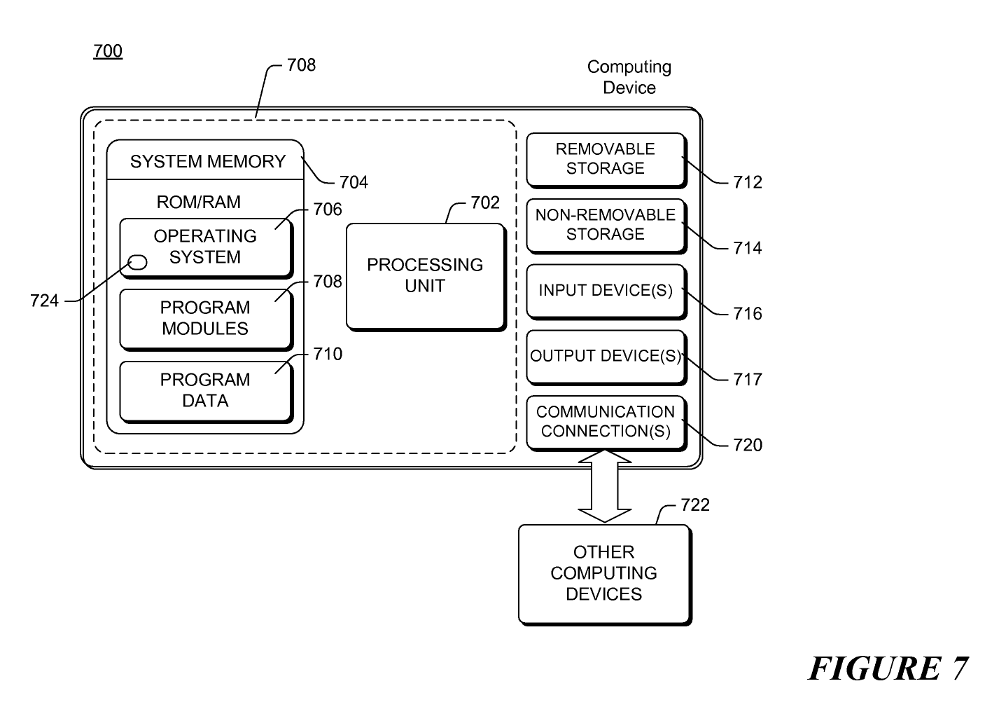

FIG. 7 illustrates a representative computing device 700 that may included in the Terminal Services Gateway (TSG) servers and Terminal Services servers. In turn, pluggable authorization policy and authentication modules, in accordance with various embodiments, may be implemented on these servers. For example, the TSG server 106 and the TS Server 112 (FIG. 1) may include representative computing device 700. However, it will readily appreciate that the various embodiments of pluggable authorization policy and authentication modules may be implemented in other computing devices, systems, and environments. The computing device 700 shown in FIG. 7 is only one example of a computing device and is not intended to suggest any limitation as to the scope of use or functionality of the computer and network architectures. Neither should the computing device 700 be interpreted as having any dependency or requirement relating to any one or combination of components illustrated in the example computing device.

In a very basic configuration, computing device 700 typically includes at least one processing unit 702 and system memory 704. Depending on the exact configuration and type of computing device, system memory 704 may be volatile (such as RAM), non-volatile (such as ROM, flash memory, etc.) or some combination of the two. System memory 704 typically includes an operating system 706, one or more program modules 708, and may include program data 710. The operating system 706 include a component-based framework 712 that supports components (including properties and events), objects, inheritance, polymorphism, reflection, and provides an object-oriented component-based application programming interface (API), such as, but by no means limited to, that of the .NET™ Framework manufactured by Microsoft Corporation, Redmond, Wash. The device 700 is of a very basic configuration demarcated by a dashed line 714. Again, a terminal may have fewer components but will interact with a computing device that may have such a basic configuration.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by removable storage 716 and non-removable storage 718. Computer storage media may include volatile and nonvolatile, removable and non-removable media implemented in any method or technology for storage of information, such as computer readable instructions, data structures, program modules, or other data. System memory 704, removable storage 716 and non-removable storage 718 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of device 700. Computing device 700 may also have input device(s) 720 such as keyboard, mouse, pen, voice input device, touch input device, etc. Output device(s) 722 such as a display, speakers, printer, etc. may also be included. These devices are well know in the art and are not discussed at length here.

Computing device 700 may also contain communication connections 724 that allow the device to communicate with other computing devices 726, such as over a network. These networks may include wired networks as well as wireless networks. Communication connections 724 are one example of communication media. Communication media may typically be embodied by computer readable instructions, data structures, program modules, etc.

It will be appreciated that the illustrated computing device 700 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The use of pluggable authorization policy and authentication modules with a TSG server may enable the TSG server to evaluate TS access requests using authorization and authentication policies that are not built into the TSG server. Thus, embodiments in accordance with this disclosure may increase the adaptability and performance of the TSG server. Similarly, the use of pluggable authorization policy and authentication modules with a TS server may also increase the adaptability and performance of the TS server.

### CONCLUSION

In closing, although the various embodiments have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. A method, comprising:
accessing one or more pluggable modules at a Terminal Services Gateway (TSG) server, wherein the one or more pluggable modules include at least one of a pluggable connection authorization policy (CAP) module, a pluggable resource authorization policy (RAP) module, or a pluggable authentication module; and
processing a TS server access request from a TS client at the TSG server using at least the one or more pluggable modules.

2. The method of claim 1, wherein the processing of a TS server access request further includes processing a connection request a connection between a TS client and a TSG server based at least on one or more policies included in the pluggable CAP module.

3. The method of claim 1, wherein the processing of a TS server access request further includes processing a resource request for a resource in the TS server based at least on one or more policies included in the pluggable RAP module.

4. The method of claim 1, wherein the processing of a TS server access request further includes processing a user authentication input from the TS client at the TSG server using the pluggable authentication module.

5. The method of claim 4, wherein the authentication input includes one of an authentication token, an authentication certificate, an authentication password, or an authentication cookie.

6. The method of claim 1, wherein the processing of a TS server access request includes processing a user authentication input to verify an identity of a corresponding user for access to a TS server.

7. The method of claim 1, wherein the TSG server is in a trusted network, and the TS client is in one of the trusted network or an untrusted network.

8. The method of claim 1, wherein the TS server and the TSG server are in different domains of the same trusted network.

9. The method of claim 1, wherein processing a TS server access request further includes using an application program interface (API) to interact with a pluggable connection authorization policy (CAP) module.

10. The method of claim 1, wherein processing a TS server access request further includes using an application program interface (API) to interact with a pluggable resource authorization policy (RAP) module.

11. The method of claim 1, wherein processing a TS server access request further includes using an application program interface (API) to interact with a pluggable authentication module.

12. The method of claim 1, wherein the TSG server includes at least one of a CAP engine or a RAP engine, and wherein processing a TS server access request includes processing a connection request based on policies in the CAP engine and the pluggable CAP module, and processing a resource request based on policies in the RAP engine and the pluggable CAP module.

13. A computer readable medium having computer-executable instructions that, when executed, perform acts comprising:
accessing one or more pluggable modules using at least one application program interface (API); and
processing a Terminal Services (TS) server access request from a TS client using the one or more pluggable modules, wherein the TS server access request includes at least one of a user authentication input, a connection request, and a resource request for a resource in the TS server.

14. The computer readable medium of claim 13, wherein the connection request is for a connection between one of the TS client and the TSG server or the TS client and the TS server.

15. The computer readable medium of claim 13, wherein accessing one or more pluggable modules include accessing a pluggable authentication module, and wherein processing a TS server access request further includes using the pluggable authentication module to verify an identity of the user for access to the TS server.

16. The computer readable medium of claim 13, wherein accessing one or more pluggable modules include accessing a pluggable connection authorization policy (CAP) module, and wherein processing a TS server access request further includes processing a connection request based on the at least one policy included in the CAP module.

17. The computer readable medium of claim 13, wherein accessing one or more pluggable modules include accessing a pluggable resource authorization policy (RAP) module, and wherein processing a TS server access request further includes processing the resource request based on the at least one policy include in the RAP module.

18. A server, the server comprising:
one or more processors; and
a first application program interface (API) for interacting with one or more pluggable modules, the one or more pluggable modules include one or more policies for determining at least one of a permissibility a connection between a Terminal Services (TS) client and one of a Terminal Services Gateway (TSG) server or a TS server, or a permissibility of access to a resource on the TS server from the TS client; and
a second API for interacting with a pluggable authentication module, the pluggable authentication module to verify the identity of a user using an authentication input received at the TS client.

19. The system of claim 18, wherein the one or more pluggable modules includes at least one of a pluggable connection authorization policy (CAP) module or a pluggable resource authorization policy (RAP) module.

20. The method of claim 18, wherein the one or more pluggable modules includes a pluggable TS server policy module.
